(19) United States
(12) Patent Application Publication
(10) Pub. No.: US 2009/0094616 A1
(43) Pub. Date: Apr. 9, 2009

(54) Comparing Middleware Configurations

(76) Inventors: Roberto Delima, Apex, NC (US); Michael F. Gering, Hillsborough, NC (US); Yongcheng Li, Cary, NC (US)

Correspondence Address: DILLON & YUDELL LLP, 8911 N. CAPITAL OF TEXAS HWY., SUITE 2110, AUSTIN, TX, 78759, US

(21) Appl. No.: 11/867,180

(22) Filed: Oct. 4, 2007

(51) Int. Cl. G06F 9/54

(52) U.S. Cl. 719/316

(57) ABSTRACT

A system and method for comparing middleware configurations on a plurality of data processing systems. A comparison manager organizes a first set of configuration objects into a first representative tree structure and a second set of configuration objects into a second representative tree structure. The comparison manager uniquely identifies (utilizing a key value) each configuration object in the first and second set of configuration objects. If at least two configuration objects have matching key values, the comparison manager compares the property values of the at least two configuration objects. The comparison manager then outputs the result of the comparison.

### BACKGROUND OF THE INVENTION

The present invention relates in general to the field of data processing systems. More particularly, the present invention relates to the field of configuring data processing systems.

As well-known in the art, “middleware” is software that couples software components and/or applications. Middleware is typically utilized to support complex, distributed applications, including web servers, content providers, and other distributed applications. Information technology (IT) professionals often attempt to compare one middleware configuration with another for configuration and/or maintenance purposes.

### BRIEF SUMMARY OF THE INVENTION

The present invention includes a system and method for comparing middleware configurations on a plurality of data processing systems. A comparison manager organizes a first set of configuration objects into a first representative tree structure and a second set of configuration objects into a second representative tree structure. The comparison manager uniquely identifies (utilizing a key value) each configuration object in the first and second set of configuration objects. If at least two configuration objects have matching key values, the comparison manager compares the property values of the at least two configuration objects. The comparison manager then outputs the result of the comparison.

### BRIEF DESCRIPTION OF THE SEVERAL VIEWS OF THE DRAWINGS

FIG. 1 is a block diagram illustrating an exemplary network according to an embodiment of the present invention;

FIG. 2 is a block diagram depicting an exemplary data processing system according to an embodiment of the present invention;

FIGS. 3A-3C are high-level logical flowcharts depicting an exemplary method for comparing middleware configurations according to an embodiment of the present invention; and

FIGS. 4A-4C are pictorial representations of various middleware configurations according to an embodiment of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

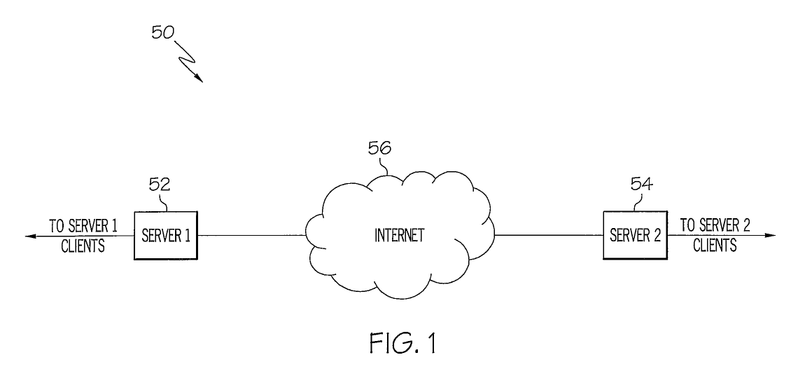

Referring now to the figures, and in particular, referring to FIG. 1, there is illustrated an exemplary network 50 in which an embodiment of the present invention may be implemented. As depicted, exemplary network 50 includes: server 1 52, server 2 54, and Internet 56. Server 1 52 and server 2 54 may be implemented as any type of server or data processing system that provides some service to a collection of clients. As shown, server 1 52 and server 2 54 may be coupled to any number of clients. While Internet 56 is utilized to couple Server 1 52 and server 2 54, those with skill in the art will appreciate that local-area network (LAN), wide-area network (WAN) utilizing Ethernet, IEEE 802.11x, or any other communications protocol may be utilized. Those with skill in the art will appreciate that exemplary network 50 may include other components such as routers, firewalls, etc. that are not germane to the discussion of the exemplary network 50 and the present invention, and therefore will not be discussed further therein.

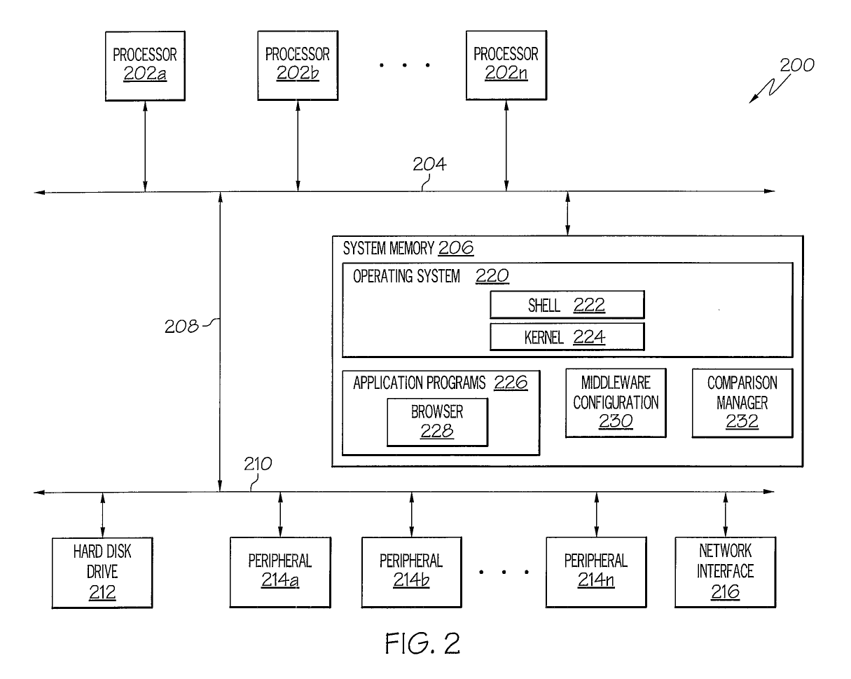

FIG. 2 is a block diagram depicting an exemplary data processing system 200, which may be utilized to implement server 1 52 and server 2 54 as shown in FIG. 1. As illustrated, exemplary data processing system 200 includes a collection of processors 202a-202n that is coupled to a system memory 206 via a system bus 204. System memory 206 may be implemented by dynamic random access memory (DRAM) modules or any other type of random access memory (RAM) module. Mezzanine bus 208 couples system bus 204 to peripheral bus 210. Coupled to peripheral bus 210 is a hard disk drive 212 for mass storage and a collection of peripherals 214a-214n, which may include, but are not limited to, optical drives, other hard disk drives, printers, and input devices, and the like. Network interface 216 enables data processing system 200 to communicate on a network, such as, but not limited to Internet 56.

Included in system memory 206 is operating system 220, which further includes a shell 222, as it is called in UNIX® operating system. UNIX is a registered trademark of The Open Group in the United States and other countries. Shell 222 provides transparent user access to resources such as application programs 226. Generally, shell 222, also called a command processor in Microsoft® Windows® operating system is generally the highest level of the operating system software hierarchy and serves as a command interpreter (Microsoft and Windows are trademarks of Microsoft Corporation in the United States, other countries, or both). Shell 222 provides a system prompt, interprets commands entered by keyboard, mouse, or other input media, and sends the interpreted command(s) to the appropriate lower levels of the operating system (e.g., kernel 224) for processing. Note that while shell 222 is a text-based, line-oriented user interface, the present invention will support other user interface modes, such as graphical, voice, gestural, etc. equally well.

As illustrated, operating system 220 also includes kernel 224 which includes lower levels of functionality for operating system 220 and application programs 226, including memory management, process and task management, disk management, and mouse and keyboard management. Application programs 226 can include browser 228, utilized for access to Internet 56 (FIG. 1), word processors, spreadsheets, and other application programs.

System memory 206 also includes middleware configuration 230. Middleware configuration 230 illustrates the configuration of computer software that couples software components and applications, such as application programs 226. To ensure interoperability of data processing systems, a comparison of middleware configurations must be determined by comparison manager 232.

According to an embodiment of the present invention, middleware configuration 230 includes a collection of artifacts organized in an array of artifacts. Some of these artifacts include, but are not limited to properties such as hostnames, timeout values, hostnames of linked systems, port values, user information, Boolean flags, and the like.

Those with skill in the art will appreciate that data processing system 200 can include many additional components not specifically illustrated in FIG. 2. Because such additional components are not necessary for an understanding of the present invention, they are not illustrated in FIG. 2 or discussed further herein. It should be understood, however, that the enhancements to data processing system 200 provided by the present invention are applicable to data processing systems of any system architecture and are no way limited to the generalized multi-processor architecture illustrated in FIG. 2.

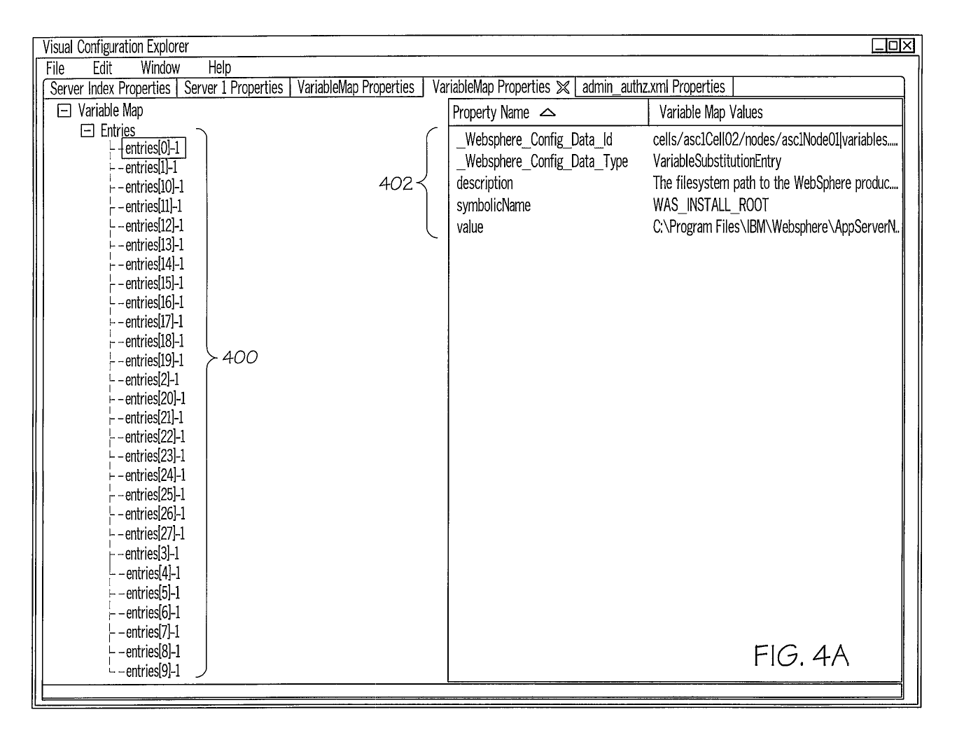

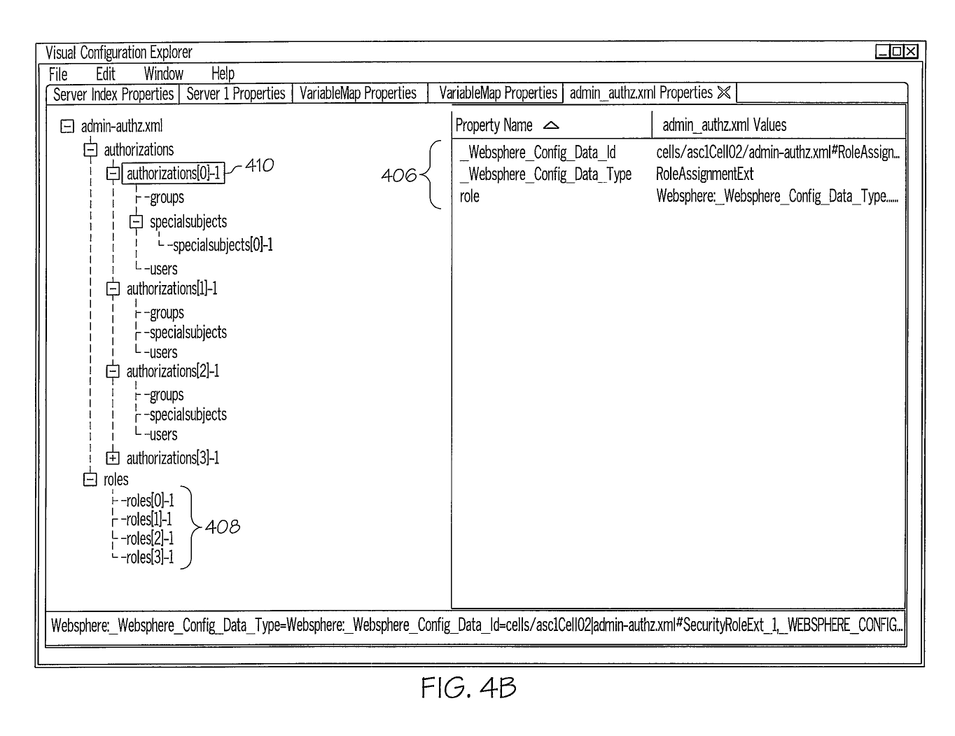

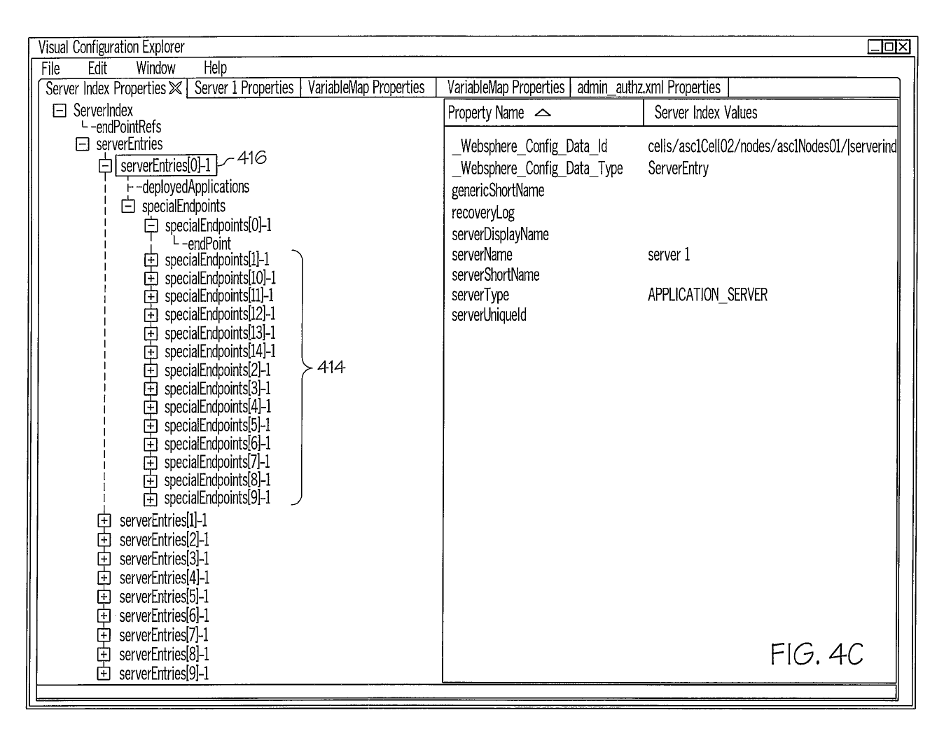

FIGS. 4A-4C includes pictorial representations of various middleware configurations according to an embodiment of the present invention. FIG. 4A depicts a middleware configuration that includes an array of configuration object entries 400. Each entry may be selected to show a collection of properties 402 within the configuration object entries. During middleware configuration comparison, two middleware configurations are received by comparison manger 232 and the array of entries in both middleware configurations are examined for differences. The differences are then reported after the comparison. FIGS. 4B-4C illustrate middleware configurations with various features such as a configuration object entry that includes a references to other entries within the array (FIG. 4B), and configuration object entries that are themselves an array of configuration object entries. Referring to FIG. 4B, the selected entry 410 includes a property (role 406) that a reference to another configuration object entry (roles 408) within the array of configuration object entries 400. With reference to FIG. 4C, the selected entry 416 further includes a nested array of entries (specialEndpoints) 414.

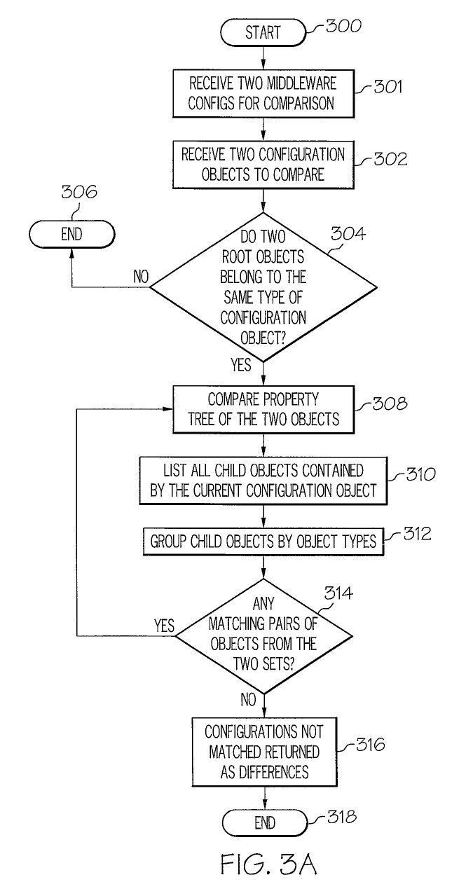

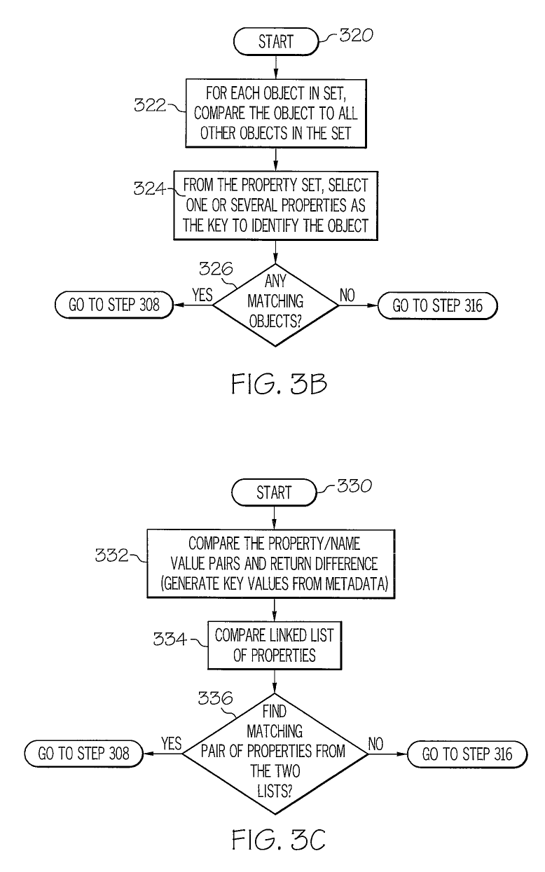

FIGS. 3A-3C are high-level logical flowcharts that illustrate an exemplary method for comparing complex middleware configurations according to an embodiment of the present invention. FIG. 3A is a high-level logical flowchart that depicts a general representation of the exemplary method for comparing complex middleware configurations according to an embodiment of the present invention. The process begins at step 300 and proceeds to step 301, which illustrates comparison manager 232 receiving a pair of middleware configurations (e.g., middleware configuration 230 (FIG. 2) from both server 1 52 (FIG. 1) and server 2 54 (FIG. 1). According to an embodiment of the present invention, a middleware configuration 230 may be embodied as an array of configuration object entries. As previously discussed, the entries themselves may further include nested arrays of configuration object entries.

The process continues to step 302, which illustrates configuration manager 232 examining two configuration objects (one from each middleware configuration) for comparison. The process proceeds to step 304, which depicts configuration manager 232 determining if the root objects of the configuration objects are the same type (e.g., both objects are of type “web server”) of configuration object. If not, the process ends, as shown in step 306. If the two root objects of the configuration objects belong to the same type, configuration manager 232 compares a property tree of the two objects. According to an embodiment of the present invention, a “property tree” is constructed of “property objects”, which can be basic name/value pairs, lists of name/value pairs, or array of lists or unspecified object types.

The process proceeds to step 310, which illustrates configuration manager 232 listing all child objects contained by the current configuration object for comparison. As previously discussed, the entries within the array of configuration object entries may include a nested array of configuration object entries that are considered child objects to the root object. The process proceeds to step 312, which depicts comparison manager 232 listing all child objects contained (e.g., nested objects) by the current configuration object. The process continues to step 314, which illustrates comparison manager 232 determining if there are any matching pairs of objects from the two sets of configuration objects. If there are matching pairs of objects, the process returns to step 308. If there are no matching pairs of objects the process continues to step 316, which shows configuration manager 232 determining that the configuration objects are not matched and returns the two configuration objects as differences. The process ends, as illustrated in step 318.

FIG. 3B is a high-level logical flowchart diagram illustrating step 314 of FIG. 3A in more detail in accordance with an embodiment of the present invention. The process begins at step 320 and continues to step 322, which shows configuration manager 232 comparing an object to all other objects within the set and performing this action for all objects in the set. The properties of the objects are utilized to determine whether two objects match or not. The process continues to step 324, which illustrates configuration manager 232 selecting one or several properties as a key to identify the object. The process continues to step 326 to determine if there are any matching objects within the set by comparing the key property name(s)/value(s) selected in step 324. If comparison manager 232 does not find a matching pair of objects, the process continues to step 316 of FIG. 3A. If comparison manager 232 finds a matching pair of objects, the process continues to step 308 of FIG. 3A.

FIG. 3C is a high-level flowchart diagram depicting step 326 of FIG. 3B in more detail in accordance with an embodiment of the present invention. The process begins at step 330 and continues to step 332, which shows configuration manager 232 comparing property/name value pairs and returning the differences between the two configuration objects. According to an embodiment of the present invention, finding the marching property/name value pairs is similar to that of finding matching objects. A key distinction is that some properties can be homed within unordered arrays of dissimilar property objects. In order to correctly compare the elements within unordered arrays, it is necessary to first find the matching sets of property objects so that they may be further compared. An embodiment of the present invention includes an algorithm that consults property metadata and generates unique key values for each element within the array. When comparing property arrays, each array is then parsed looking for matching key values within the contained elements, and when a match is found, the objects may then be compared by comparison manager 232, as illustrated in steps 334 and 336. If comparison manager 232 does not find a matching pair of two properties from the two lists, the process continues to step 316 of FIG. 3A. If comparison manager 232 finds a matching pair of two properties from the two lists, the process continues to step 308 of FIG. 3A.

As discussed, the present invention includes a system and method for comparing middleware configurations on a plurality of data processing systems. A comparison manager organizes a first set of configuration objects into a first representative tree structure and a second set of configuration objects into a second representative tree structure. The comparison manager uniquely identifies (utilizing a key value) each configuration object in the first and second set of configuration objects. If at least two configuration objects have matching key values, the comparison manager compares the property values of the at least two configuration objects. The comparison manager then outputs the result of the comparison.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for comparing middleware configurations on a plurality of data processing systems, said method comprising:
organizing a first plurality of configuration objects into a first representative tree structure and a second plurality of configuration objects into a second representative tree, wherein each configuration object among said first and second plurality of configuration objects further includes a configuration object name, at least one associated property, and at least one associated property value;
identifying each configuration object among said first and second plurality of configuration objects by hashing said each configuration object name and said at least one associated property to generate a key value for each configuration object among said first and second plurality of configuration objects;
determining if at least a first configuration object from said first plurality of configuration objects and at least a second configuration object from said second plurality of configuration objects have matching key values;
in response to determining at least said first configuration object from said first plurality of configuration objects and at least said second configuration object from said second plurality of configuration objects have matching key values, comparing if at least one associated property value from said at least said first configuration object is different from said at least one associated property value from said at least said second configuration object; and
in response to said comparing, outputting a result of said comparing.

2. The computer-implementable method according to claim 1, wherein said result of said comparing includes at least one configuration object that does not match any other configuration object.

3. The computer-implementable method according to claim 1, further comprising:
grouping each configuration object in said first and second plurality of configuration objects by object types.

4. A system for comparing middleware configurations on a plurality of data processing systems, said system comprising:
at least one processor;
a database coupled to said at least one processor;
a computer-usable medium embodying computer program code, the computer-usable medium being coupled to the data bus, the computer program code comprising instructions executable by the processor and configured for:
organizing a first plurality of configuration objects into a first representative tree structure and a second plurality of configuration objects into a second representative tree, wherein each configuration object among said first and second plurality of configuration objects further includes a configuration object name, at least one associated property, and at least one associated property value;
identifying each configuration object among said first and second plurality of configuration objects by hashing said each configuration object name and said at least one associated property to generate a key value for each configuration object among said first and second plurality of configuration objects;
determining if at least a first configuration object from said first plurality of configuration objects and at least a second configuration object from said second plurality of configuration objects have matching key values;
in response to determining at least said first configuration object from said first plurality of configuration objects and at least said second configuration object from said second plurality of configuration objects have matching key values, comparing if at least one associated property value from said at least said first configuration object is different from said at least one associated property value from said at least said second configuration object; and
in response to said comparing, outputting a result of said comparing.

5. The system according to claim 4, wherein said result of said comparing includes at least one configuration object that does not match any other configuration object.

6. The system according to claim 4, wherein said instructions are further configured for:
grouping each configuration object in said first and second plurality of configuration objects by object types.
